(19) United States
(12) Patent Application Publication
(10) Pub. No.: US 2002/0178603 A1
(43) Pub. Date: Dec. 5, 2002

(54) Wafer drying apparatus using isopropanol

(76) Inventors: Chuan-Ju Chuang, Hsinchu Hsien (TW); Lung-Hui Tsai, Hsinchu City (TW); Su-Ling Tseng, Hsinchu Hsien (TW)

Correspondence Address: SUPREME PATENT SERVICES, POST OFFICE BOX 2339, SARATOGA, CA, 95070, US

(21) Appl. No.: 09/872,901

(22) Filed: Jun. 2, 2001

(51) Int. Cl. F26B 19/00

(52) U.S. Cl. 34/61

(57) ABSTRACT

An apparatus for drying wafers has at least one rotatable cylinder in addition to a plurality of wafer slots. A wafer is supported in a slot by means of a plurality of wafer holders. The rotatable cylinder is in contact with the edge of a wafer. By rotating the rotatable cylinder, a wafer is also rotated. An isopropanol vapor flows through a wafer surface. Because of the wafer rotation, the isopropanol vapor flows through the wafer surface in different directions so that water drops or moistures can be carried away from the wafer and dried thoroughly.

### FIELD OF THE INVENTION

The present invention generally relates to the structure of a wafer drying apparatus, and more specifically to an improved structure of wafer drying apparatus using isopropanol.

### BACKGROUND OF THE INVENTION

In the process of manufacturing semiconductor devices, the step of rinsing and cleaning a wafer is used to remove residues on the wafer surface. For example, after the removal of a photo-resist layer using chemicals or after an etching step, a wafer has to be cleaned, rinsed and dried. If water drops or moistures are left on the wafer surface, the packaging of the wafer may have problems of poor adhesion, layer drop-off, and package deformation. Moreover, the semiconductor device may malfunction or burn out because of short circuit.

A conventional wafer drying method use an apparatus that has wafer slots to hold wafers. An isopropanol vapor is flowed through the surface of wafers to carry and move away the moistures in order to dry the wafers. In the advanced semiconductor devices, especially in a highly integrated system on chip (SOC), the device circuits are laid out and divided into many regions. The topology on each region results in some recessed areas that are perpendicular to the flowing direction of the isopropanol vapor. Consequently, water drops or moistures can not be dried and removed completely from the wafer in these areas.

### SUMMARY OF THE INVENTION

This invention has been made to overcome the above mentioned drawback of a conventional wafer drying apparatus. The primary object of this invention is to provide a new structure for the apparatus so that an isopropanol vapor can flow through the wafer in different directions for thoroughly removing the water drops and moistures from a wafer surface and thus drying the wafer.

Accordingly, the wafer drying apparatus of this invention comprises a plurality of wafer holders and a rotatable cylinder. A plurality of slots are formed on the apparatus to hold multiple wafers. The rotatable cylinder is located in close contact with the edge of each wafer in a direction perpendicular to the wafer surface. The rotation of the cylinder also causes the wafers to rotate. An isopropanol vapor is flowed through the wafer surface. The rotation of the wafer make the isopropanol vapor flow through the semiconductor device on the wafer surface from different directions to remove water drops or moistures completely.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a cross sectional view of the wafer drying apparatus according to this invention.

FIG. 2 is another cross sectional view of the wafer drying apparatus along line AA of FIG. 1 according to this invention.

FIG. 3 is another cross sectional view of the wafer drying apparatus along line BB of FIG. 1 according to this invention.

FIG. 4 illustrates a magnified view of a circuit unit which has a water drop on it when a wafer is at an angle.

FIG. 5 illustrates a magnified view of the circuit unit and the water drop shown in FIG. 4 when the wafer is rotated to another angle.

### DETAILED DESCRIPTION OF THE PREFERRED EMBODIMENTS

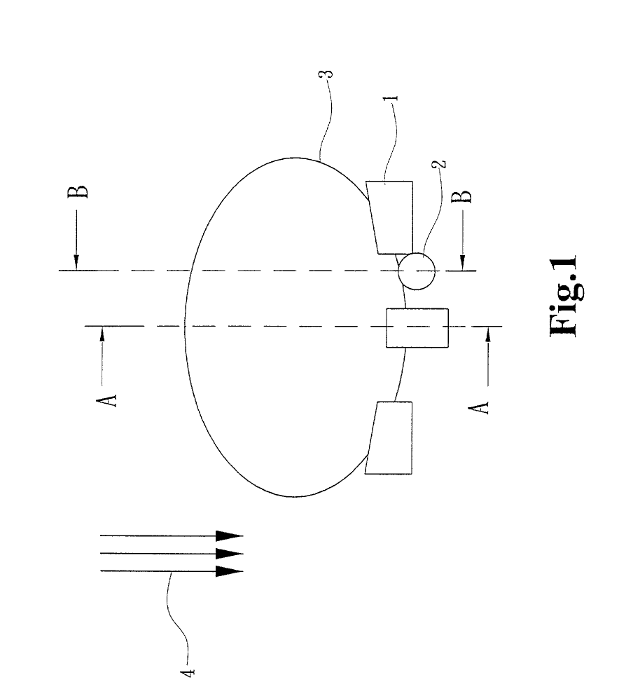

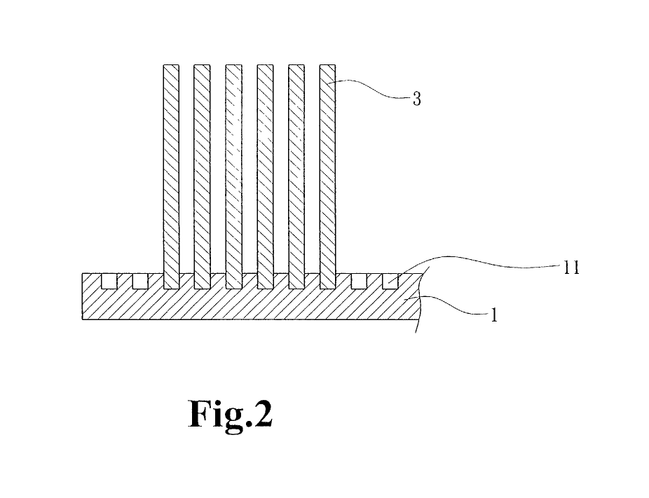

With reference to FIG. 1, a cross sectional view of the wafer drying apparatus according to this invention is shown. The apparatus comprises a plurality of wafer holders 1 and at least one rotatable cylinder 2. A side view of the apparatus is shown in FIG. 2. As can be seen, a plurality of wafers 3 can be supported on a plurality of slots 11 formed on the apparatus in cooperation with the wafer holders 1.

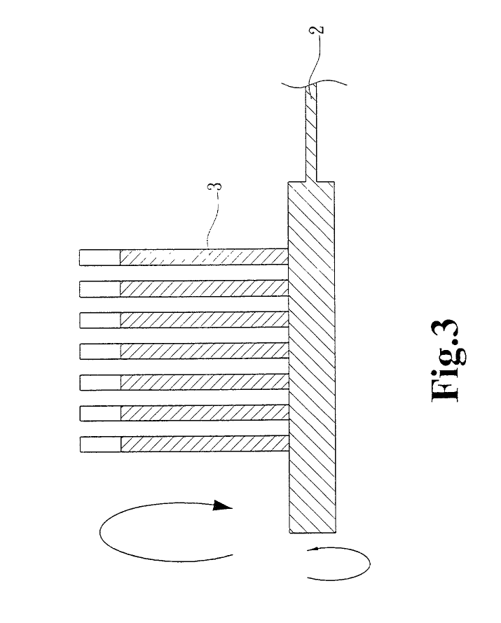

According to this invention, the rotatable cylinder 2 is located next to the edge of each wafer 3. The rotatable cylinder is in close contact with each wafer in such a way that the rotation of the cylinder also causes the wafers to rotate on the apparatus with the support of the wafer holders 1. As shown in FIG. 3, the rotatable cylinder 2 is rotated counter clock wise and the wafers 3 are rotated clock wise. Because of the support of the wafer holders, wafers remains on the slots when they are rotated. An isopropanol vapor flows through the wafer surface in a vertical direction 4 as shown in FIG. 1.

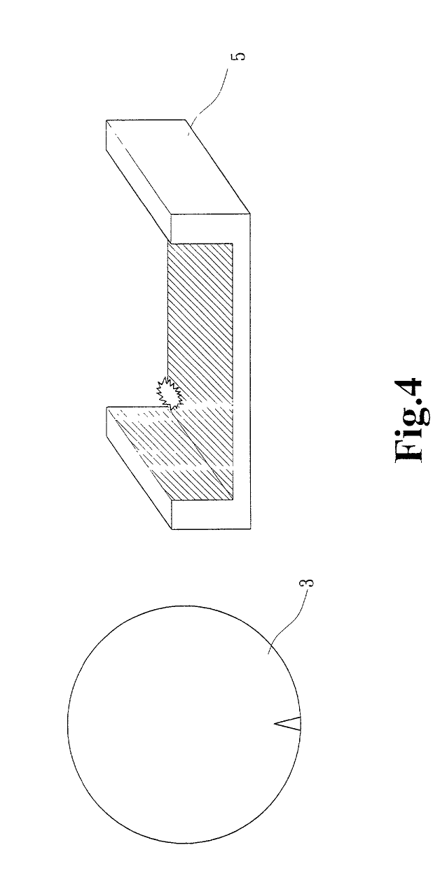

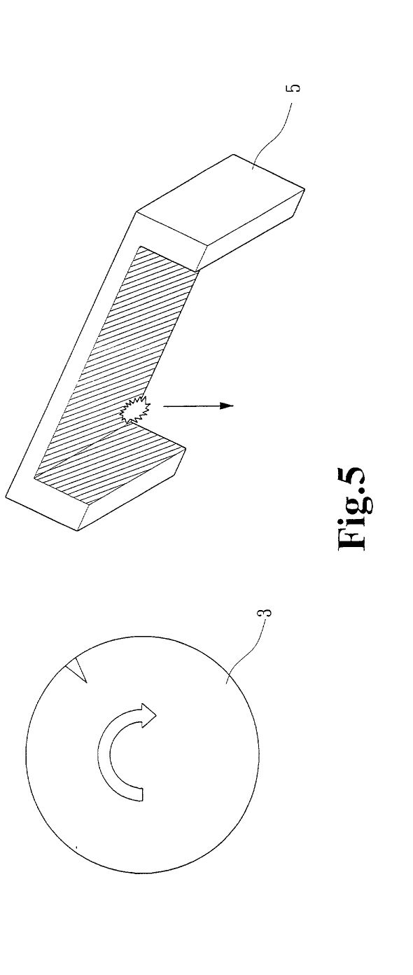

FIG. 4 shows a magnified view of a circuit unit 5, which has a water drop on it, on a wafer 3. When the wafer is positioned in an angle, the water drop may be blocked by the circuit unit 5 if the isopropanel is flowing from one direction. FIG. 5 shows another magnified view of the circuit unit 5 and the water drop when the wafer 3 is rotated to a different direction. The water drop may be exposed and no longer blocked by the circuit unit. Therefore, although the isopropanol vapor only flows in one direction, it effectively flows over the circuits of the semiconductor device from various directions because of the rotation of the wafer. Therefore, the isopropanol vapor flows over each circuit region regardless of the different topology in each region. Water drops or moistures can thus be removed from the wafer surface very thoroughly.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for drying wafers comprising:
a plurality of wafer slots;
a plurality of holders for supporting a wafer on each wafer slot;
at least one rotatable cylinder installed on said apparatus, said rotatable cylinder being located in close contact with the edge of each wafer supported on a wafer slot and in a direction perpendicular to the wafer surface of each wafer.

2. A method of drying wafers supported on the apparatus as claimed in claim 1, comprising the steps of rotating said rotatable cylinder and flowing an isopropanol vapor through the wafer surface of each wafer in a direction parallel to the wafer surface.
